(19) United States
(12) Patent Application Publication
(10) Pub. No.: US 2017/0078837 A1
(43) Pub. Date: Mar. 16, 2017

(54) METHODS AND DEVICES FOR LOCATING WEARABLE DEVICE

(71) Applicant: Xiaomi Inc., Beijing (CN)

(72) Inventors: Xin LIANG, Beijing (CN); Kangxi TAN, Beijing (CN); Yi RU, Beijing (CN); Li HE, Beijing (CN)

(73) Assignee: Xiaomi Inc.

(21) Appl. No.: 15/264,799

(22) Filed: Sep. 14, 2016

(30) Foreign Application Priority Data
Sep. 16, 2015 (CN) 201510589706.0

(51) Int. Cl. H04W 4/00; H04W 76/02; H04L 29/08; H04W 4/02

(52) U.S. Cl. CPC H04W 4/008; H04W 4/02; H04W 76/023; H04L 67/18

(57) ABSTRACT

The present disclosure relates to methods and devices for locating a wearable device. The method includes: determining, by the wearable device, whether a first short range communication connection between the wearable device and a first terminal is disconnected; and when it is determined that the first short range communication connection is disconnected, broadcasting, by the wearable device, a notification message configured to instruct a second terminal to: establish a second short range communication connection with the wearable device, and send a connection notification to a server, wherein the server locates the wearable device according to the second terminal.

### CROSS-REFERENCE TO RELATED APPLICATIONS

This application is based upon and claims priority to Chinese Patent Application No. 201510589706.0, filed Sep. 16, 2015, the entire contents of which are incorporated herein by reference.

### TECHNICAL FIELD

The present disclosure generally relates to computer technologies and, more particularly, to methods and devices for locating a wearable device.

### BACKGROUND

With the proliferation of smart terminals, derivative products of the smart terminals are also widely used, such as smart wristbands with a loss-prevention function. A smart wristband worn by a child may be connected to a terminal carried by a parent of the child, via wireless communications, such as a Bluetooth connection. Conventionally, when the child wearing the smart wristband moves away from the parent more than a given distance, the Bluetooth connection is disconnected, and the parent's terminal will generate an alarm. However, this method does not help the parent to quickly find the child, especially in a crowded environment.

### SUMMARY

According to a first aspect of the present disclosure, there is provided a method for locating a wearable device, comprising: determining, by the wearable device, whether a first short range communication connection between the wearable device and a first terminal is disconnected; and when it is determined that the first short range communication connection is disconnected, broadcasting, by the wearable device, a notification message configured to instruct a second terminal to: establish a second short range communication connection with the wearable device, and send a connection notification to a server, wherein the server locates the wearable device according to the second terminal.

According to a second aspect of the present disclosure, there is provided a wearable device, comprising: a transmitter; a processor; and a memory for storing instructions executable by the processor; wherein: the processor is configured to determine whether a first short range communication connection between the wearable device and a first terminal is disconnected; and the transmitter is configured to, when the processor determines that the first short range communication connection with the first terminal is disconnected, broadcast a notification message configured to instruct a second terminal to: establish a second short range communication connection with the wearable device, and send a connection notification to a server, wherein the server locates the wearable device according to the second terminal.

According to a third aspect of the present disclosure, there is provided a terminal, comprising: a receiver; a transmitter; a processor; and a memory for storing instructions executable by the processor; wherein: the receiver is configured to receive a notification message broadcast by a wearable device, wherein the notification message is configured to instruct the terminal to establish a short range communication connection with the wearable device, and to report a connection notification to a server, wherein the server locates the wearable device according to the terminal; the processor is configured to establish the short range communication connection with the wearable device; and the transmitter is configured to send the connection notification to the server, the connection notification being configured to indicate that the terminal has established the short range communication connection with the wearable device.

According to a fourth aspect of the present disclosure, there is provided a server, comprising: a receiver; a transmitter; a processor; and a memory for storing instructions executable by the processor; wherein: the receiver is configured to: receive, from a first terminal, location information of the first terminal and requesting-assistance information indicating that the first terminal is disconnected from a wearable device, and receive, from a second terminal, location information of the second terminal and identity information of a user who uses the wearable device, the second terminal being within a predetermined distance from the first terminal; the transmitter is configured to send the second terminal a request for activating a monitoring function of the second terminal, wherein the second terminal activates a short range communication detection function to establish a short range communication connection with the wearable device; and the processor is configured to locate the wearable device according to the location information of the second terminal.

It is to be understood that both the foregoing general description and the following detailed description are exemplary and explanatory only and are not restrictive of the present disclosure, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart of a method for locating a wearable device, according to an exemplary embodiment.

FIG. 2 is a flowchart of a method for locating a wearable device, according to an exemplary embodiment.

FIG. 3 is a flowchart of a method for locating a wearable device, according to an exemplary embodiment.

FIG. 4 is a flowchart of a method for locating a wearable device, according to an exemplary embodiment.

FIG. 5 is a flowchart of a method for locating a wearable device, according to an exemplary embodiment.

FIG. 6 is a flowchart of a method for locating a wearable device, according to an exemplary embodiment.

FIG. 7 is a block diagram of a wearable device, according to an exemplary embodiment.

FIG. 8 is a block diagram of a wearable device, according to an exemplary embodiment.

FIG. 9 is a block diagram of a wearable device, according to an exemplary embodiment.

FIG. 10 is a block diagram of a wearable device, according to an exemplary embodiment.

FIG. 11 is a block diagram of a terminal, according to an exemplary embodiment.

FIG. 12 is a block diagram of a terminal, according to an exemplary embodiment.

FIG. 13 is a block diagram of a terminal, according to an exemplary embodiment.

FIG. 14 is a block diagram of a server, according to an exemplary embodiment.

FIG. 15 is a block diagram of a server, according to an exemplary embodiment.

FIG. 16 is a block diagram of a wearable device, according to an exemplary embodiment.

FIG. 17 is a block diagram of a terminal, according to an exemplary embodiment.

FIG. 18 is a block diagram of a server, according to an exemplary embodiment.

FIG. 19 is a schematic diagram illustrating a system for locating a wearable device, according to an exemplary embodiment.

FIG. 20 is a block diagram of a wearable device, according to an exemplary embodiment.

FIG. 21 is a block diagram of a terminal, according to an exemplary embodiment.

FIG. 22 is a block diagram of a server, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the present disclosure as recited in the appended claims.

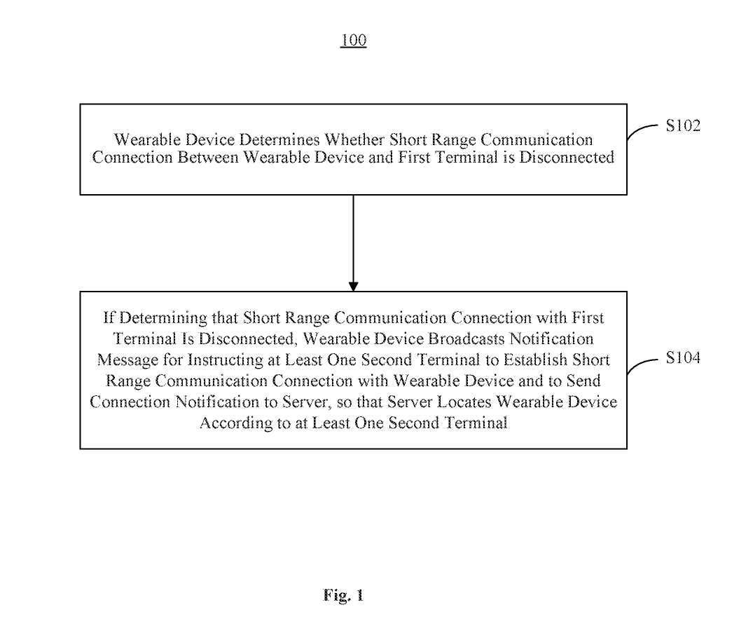

FIG. 1 is a flowchart of a method 100 for locating a wearable device, according to an exemplary embodiment. For example, the method 100 may be used in a wearable device. The wearable device may be a smart device capable of being directly worn by a user, such as a smart wristband or a smart watch. After the wearable device is disconnected from a first terminal, the method 100 may be used to enable the wearable device to be quickly located by other terminals. Referring to FIG. 1, the method 100 includes the following steps.

In step S102, the wearable device determines whether a short range communication connection between the wearable device and a first terminal is disconnected.

In exemplary embodiments, the wearable device has a detection function capable of detecting whether the wearable device is connected to or disconnected from the first terminal. The wearable device may activate such bidirectional detection function when the wearable device is connected to the first terminal. The short range communication connection refers to a wireless connection available only within a certain distance range, for example, a Bluetooth connection, a Near Field Communication (NFC) connection, and the like.

In step S104, if the wearable device determines that the short range communication connection with the first terminal is disconnected, the wearable device broadcasts a notification message. The notification message instructs at least one second terminal to establish a short range communication connection with the wearable device and to send a connection notification to a server so that the server locates the wearable device according to the at least one second terminal.

In exemplary embodiments, the wearable device broadcasts the notification message using Bluetooth, or any other radio signals, such as a wireless local area network or base station signals. The notification message is configured to notify at least one second terminal within a certain distance from the wearable device that the wearable device is disconnected from the first terminal. The notification message also requests to establish a short range communication connection between the wearable device and the at least one second terminal. The notification message is further configured to instruct the at least one second terminal to notify the server that at least one second terminal has established the connection with the wearable device, so that the server can obtain the location of the at least one second terminal to quickly locate the wearable device.

In some embodiments, the notification message may include identity information of a user who uses the wearable device and a signal for requesting assistance. The notification message may be further configured to instruct the at least one second terminal to report to the server location information of the at least one second terminal and the identity information of the user. If the notification message includes the identity information and the signal for requesting assistance, the at least one second terminal may obtain the location information of the at least one second terminal via a Global Positioning System (GPS), and report the identity information and the location information to the server. The server can locate the missing wearable device according to the location information of the at least one second terminal, and quickly locate the wearable device.

According to the method 100, after a wearable device is disconnected from a first terminal, the wearable device broadcasts a notification message. After a short range communication connection between the wearable device and at least one second terminal is established, the at least one second terminal reports the identity of the wearable device to a server. The server locates the wearable device according to the at least one second terminal. Therefore, the method 100 can quickly determine the location of the wearable device after the wearable device is disconnected from the first terminal, and improve the speed and accuracy for locating the wearable device.

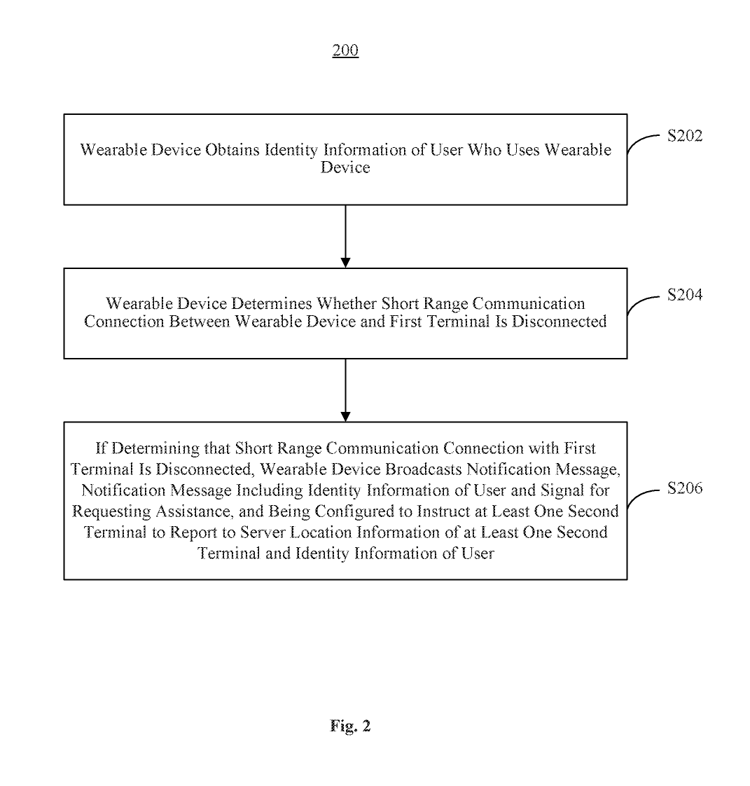

FIG. 2 is a flowchart of a method 200 for locating a wearable device, according to an exemplary embodiment. For example, the method 200 may be used in a wearable device. Referring to FIG. 2, the method 200 is described on the basis of the embodiment shown in FIG. 1 and includes the following steps.

In step S202, the wearable device obtains identity information of a user who uses the wearable device.

After establishing a connection, e.g., a short range communication connection, with a first terminal, the wearable device may obtain the identity information of the user using the wearable device. For example, the identify information may include name, guardian (e.g., if the user is a child), contact numbers, home address, and the like. In exemplary embodiments, the identity information may be obtained according to at least the following two approaches.

In the first approach, the wearable device receives the identity information sent by the first terminal, and locally stores the received identity information. For example, a user can input the identity information on the first terminal and then send the identity information to the wearable device.

In the second approach, the wearable device collects the identity information directly input by a user on the wearable device, and locally stores the identity information. For example, the wearable device may have an input interface, such as a touch screen, a microphone or, or a display, for the user to directly enter the identity information into the wearable device.

In step S204, the wearable device determines whether the short range communication connection between the wearable device and the first terminal is disconnected.

In step S206, if the wearable device determines that the short range communication connection with the first terminal is disconnected, the wearable device broadcasts a notification message. The notification message includes the identity information of the user who uses the wearable device and a signal for requesting assistance. The notification message is further configured to instruct at least one second terminal to report to a server the location information of the at least one second terminal and the identity information of the user.

In exemplary embodiments, when determining that the short range communication connection between the wearable device and the first terminal is disconnected, the wearable device broadcasts the notification message to at least one second terminal that is in proximity to the wearable device. The wearable device may broadcast the notification message via Bluetooth, a wireless local area network, or a base station signal.

The notification message instructs the at least one second terminal to establish a short range communication connection with the wearable device. If the at least one second terminal agrees to form the connection, the at least one second terminal may activate a short range communication function to establish the connection with the wearable device, and then notify the server of the location information of the at least one second terminal and the identity information of the user who uses the wearable device, so that the server can locate the wearable device.

In exemplary embodiments, the short range communications between the wearable device and the first terminal or the second terminals include but not limited to Bluetooth connections. In one embodiment, the connection may be formed via Bluetooth technology, so as to save power and reduce cost.

According to the method 200, before the wearable device is disconnected from the first terminal, the wearable device obtains identity information of a user who uses the wearable device, so that the wearable device can send the identity information and requesting-assistance information to second terminals when the connection is disconnected. The wearable device may broadcast the notification message in any suitable manners, such as via Bluetooth, via a wireless local area network, or via base station signals. This way, the wearable device may be located quickly and accurately.

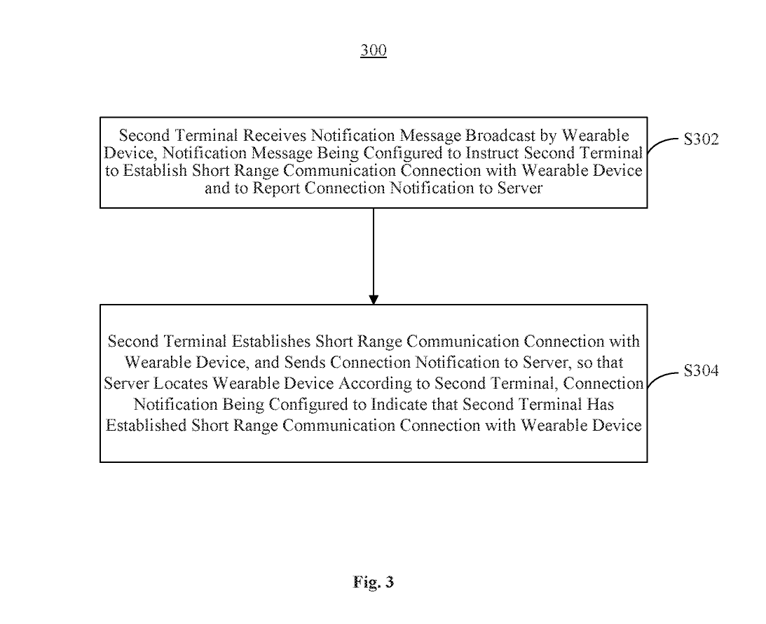

FIG. 3 is a flowchart of a method 300 for locating a wearable device, according to an exemplary embodiment. For example, the method 300 may be used in a second terminal. The second terminal may be a device with a short range communication function, such as a mobile phone, a laptop, a tablet computer, and the like. The method 300 includes the following steps.

In step S302, the second terminal receives a notification message broadcast by a wearable device. The notification message is configured to instruct the second terminal to establish a short range communication connection with the wearable device and to report a connection notification to a server.

In step S304, the second terminal establishes the short range communication connection with the wearable device, and sends a connection notification to the server, so that the server locates the wearable device according to the second terminal. The connection notification is configured to indicate that the second terminal has established the short range communication connection with the wearable device.

In exemplary embodiments, the second terminal is one of the devices that is in proximity to the wearable device and are located within a range suitable for short range communications. After the second terminal receives the notification message broadcast by the wearable device and authorizes the establishment of a connection with the wearable device, the second terminal sends the connection notification to the server.

The connection notification may carry the identity of the wearable device, so that the server can distinguish multiple wearable devices according to identities and locate the wearable device that needs to be located.

According to the method 300, after receiving a notification message from a nearby wearable device, the second terminal establishes a connection with the wearable device, and reports to the server that the second terminal has established a connection with the wearable device, so that the server locates the wearable according to the second terminal. In this manner, a missing wearable device can be quickly located.

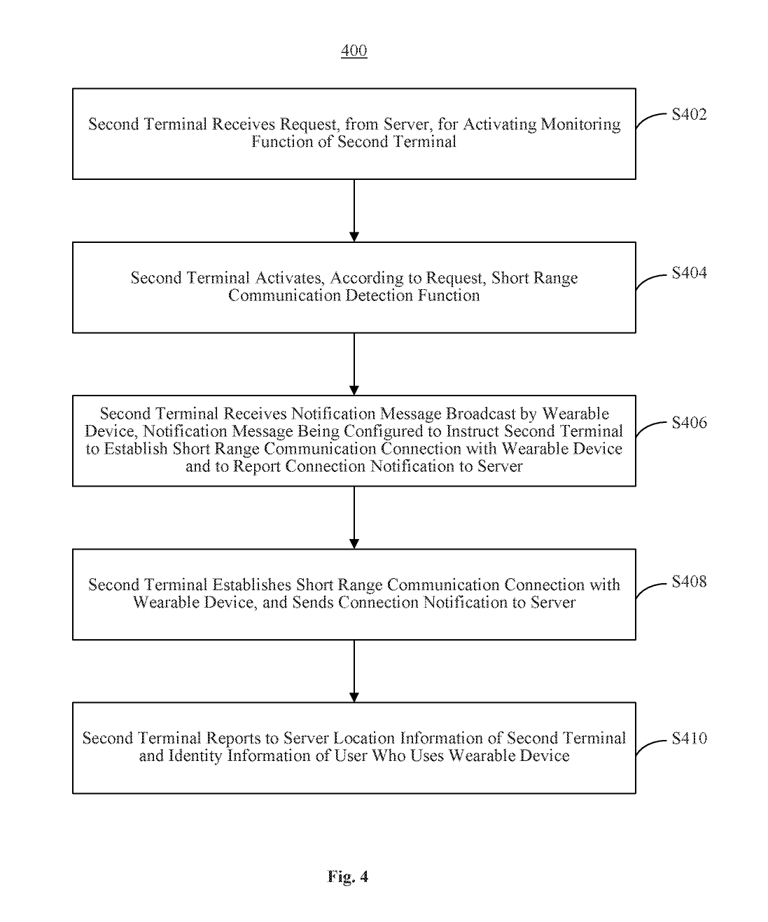

FIG. 4 is a flowchart of a method 400 for locating a wearable device, according to an exemplary embodiment. For example, the method 400 may be used in a second terminal. Referring to FIG. 4, the method 400 is described on the basis of the embodiment shown in FIG. 3, and includes the following steps.

In step S402, the second terminal receives a request, from a server, for activating a monitoring function of the second terminal.

In step S404, the second terminal activates, according to the request, a short range communication detection function.

In step S406, the second terminal receives a notification message broadcast by a wearable device. The notification message is configured to instruct the second terminal to establish a short range communication connection with the wearable device and to report a connection notification to the server.

In step S408, the second terminal establishes the short range communication connection with the wearable device, and sends the connection notification to the server.

In step S410, the second terminal reports to the server location information of the second terminal and identity information of the user who uses the wearable device.

In exemplary embodiments, after the first terminal detects that the first terminal is disconnected from the wearable device, the first terminal obtains the location information of the first terminal, and sends the location information and/or the nearby base station information to the server. The first terminal also sends to the server a request for locating the wearable device. After receiving the request, the server sends a request for activating a monitoring function to one or more second terminals, such as mobile phones, in proximity to the first terminal. If a second terminal accepts the request, the second terminal activates the detection function and establishes a short range communication connection with the wearable device.

The one or more second terminals may use a GPS function to obtain the location information of each second terminal Each second terminal reports the location information of the second terminal and the identity information of the user who uses the wearable device to the server. The server may locate the wearable device according to the location information of the one or more second terminals, and notify the first terminal that the wearable device is located.

In some embodiments, in order to save power and reduce costs, the short range communication connection established between the second terminal and the wearable device may be a Bluetooth connection. The connection between the wearable device and the first terminal may also be a Bluetooth connection.

According to the method 400, a second terminal in proximity to the first terminal receives instructions from the server to activate a short range communication detection function of the second terminal. The server then controls the second terminal to locate the wearable device. In this manner, after the wearable device is lost, the wearable device can be located using the location information of the second terminals that are in proximity to the first terminal and form a connection with the wearable device.

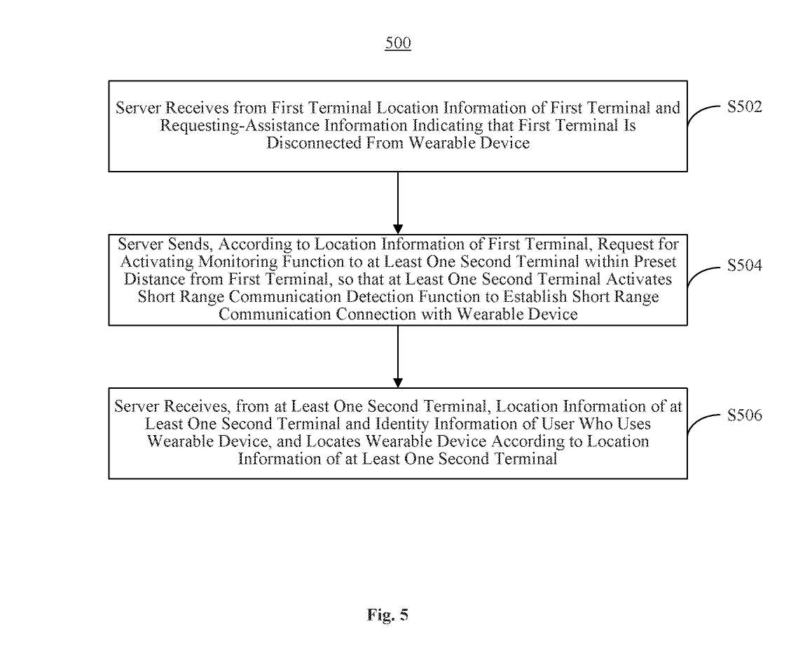

FIG. 5 is a flowchart of a method 500 for locating a wearable device, according to an exemplary embodiment. For example, the method 500 may be used in a server. Referring to FIG. 5, the method 500 includes the following steps.

In step S502, the server receives, from a first terminal, location information of the first terminal and requesting-assistance information. The requesting-assistance information indicates that the first terminal is disconnected from a wearable device.

In step S504, the server sends, according to the location information of the first terminal, a request for activating a monitoring function to at least one second terminal within a preset distance from the first terminal Based on the request, the at least one second terminal activates a short range communication detection function to establish a short range communication connection with the wearable device.

In step S506, the server receives, from the at least one second terminal, location information of the at least one second terminal and identity information of a user who uses the wearable device, and locates the wearable device according to the location information of the at least one second terminal

According to the method 500, the server receives, from the first terminal, the location information of the first terminal and requesting-assistance information. The requesting-assistance information indicates that the first terminal is disconnected from the wearable device and requests the server to locate the wearable device. According to the location information of the first terminal, the server sends a request for activating a monitoring function to at least one second terminal within a preset distance from the first terminal. The at least one second terminal reports the location information of the respective second terminal to the server. By controlling the second terminals in proximity to the wearable device, the server may accurately and efficiently locate the wearable device.

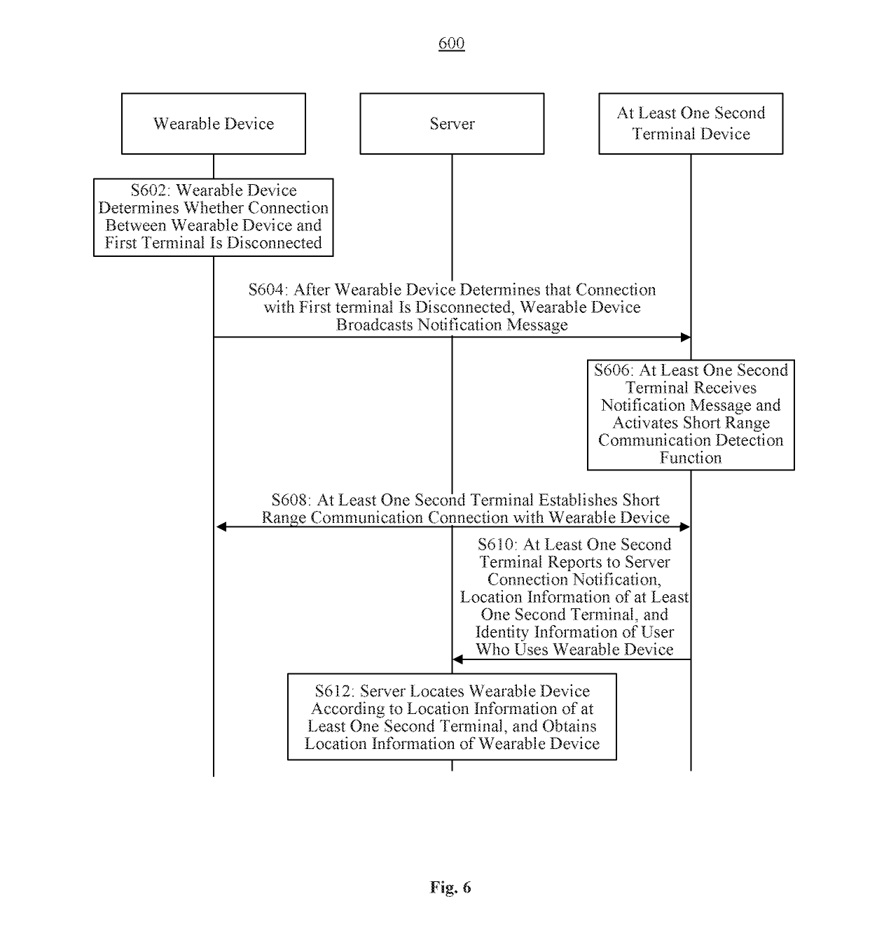

FIG. 6 is a flowchart of a method 600 for locating a wearable device, according to an exemplary embodiment. For example, the method 600 may be performed by a system including a wearable device, at least one second terminal, and a server. Referring to FIG. 6, the method 600 includes the following steps.

In step S602, the wearable device determines whether a connection between the wearable device and a first terminal is disconnected.

In step S604, after the wearable device determines that the connection with the first terminal is disconnected, the wearable device broadcasts a notification message.

In step S606, at least one second terminal receives the notification message and activates a short range communication detection function.

In step S608, the at least one second terminal establishes a short range communication connection with the wearable device.

In step S610, the at least one second terminal reports to the server a connection notification, location information of the at least one second terminal, and identity information of the user who uses the wearable device.

In step S612, the server locates the wearable device according to the location information of the at least one second terminal, and obtains the location information of the wearable device.

Optionally, after the first terminal detects the disconnection from the wearable device, the first terminal may send the server the location information of the first terminal and a request for locating the wearable device. The server may then provide the location information of the wearable device to the first terminal, so that the first terminal can locate the wearable device.

The methods disclosed in the above embodiments may be used for finding lost wearable devices, or for locating missing children or elders through the wearable devices worn by the children or elders. The wearable device may take the form of portable accessories that have computation capabilities and are connectable to mobile phones and other types of terminals. For example, the wearable devices may include watch type products worn on a user's wrist, such as smart watches, smart wristbands, smart bracelets, and the like. The wearable devices may also include shoes type products worn on the user's feet or legs, such as shoes, stockings, and the like. The wearable devices may also include glasses type products worn on the user's head, such as smart glasses, helmets, head bands, and the like. The wearable devices may further include smart clothing, schoolbags, walking sticks, fashion accessories, etc. The present disclosure does not limit the types and forms of the wearable devices.

The following are two examples illustrating the above-described methods. In the first example, a smart wristband is worn by a child. The smart wristband may establish a Bluetooth connection with a mobile phone (i.e., a first mobile phone) of the child's parents. The smart wristband may activate a bi-directional detection function, so that the smart wristband may detect whether the smart wristband is disconnected from the first mobile phone. When the disconnection is detected, the smart wristband broadcasts a notification message via Bluetooth or other radio communication technologies, such as WiFi. If one or more second mobile phones in the vicinity of the smart wristband agree to form a connection with the smart wristband, each second mobile phone may perform Bluetooth scanning at a predetermined time interval, so as to establish a Bluetooth connection with the smart wristband. Each second mobile phone then reports to a server that the second mobile phone has established a connection with the smart wristband. Subsequently, the server may locate the smart wristband according to the one or more second mobile phones.

In the second example, after the first mobile phone detects that the Bluetooth connection with the smart wristband is disconnected, the first mobile phone automatically reports the location information of the first mobile phone and/or the base station information to the server. The server automatically controls the second mobile phones in the vicinity of the first mobile phone and/or the base stations to activate the respective Bluetooth monitoring functions. If the second mobile phones activate the monitoring functions and establish Bluetooth connections with the smart wristband, the second mobile phones may promptly report the GPS information of the second mobile phones and the identity information of the smart wristband to the server. The server then locates the smart wristband according to the GPS information and the identity information.

According to the methods in the present disclosure, the wearable device or the server triggers the terminals in proximity to the wearable device to enter into a monitoring mode, so as to monitor the information broadcast by the wearable device. The terminals establish connections with the wearable device and report their respective location information to the server. The server then locates the wearable device according to the location information of the terminal in proximity to the wearable device. In preferred embodiments, the connections between the wearable device and the terminals may be Bluetooth connections, so as to reduce costs.

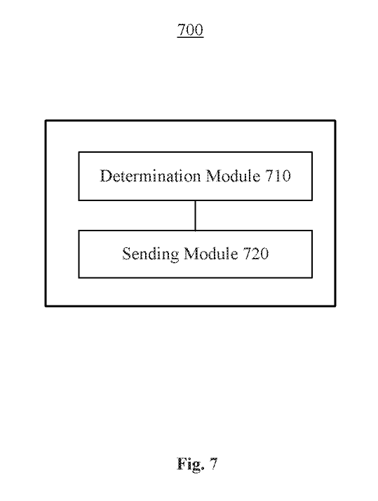

FIG. 7 is a block diagram of a wearable device 700, according to an exemplary embodiment. Referring to FIG. 7, the wearable device 700 includes a determination module 710 and a sending module 720.

The determination module 710 is configured to determine whether a short range communication connection between the wearable device 700 and a first terminal is disconnected.

The sending module 720 is configured to, if the determination module 710 determines that the short range communication connection with the first terminal is disconnected, broadcast a notification message for instructing at least one second terminal to establish a short range communication connection with the wearable device 700 and to send a connection notification to a server, so that the server locates the wearable device 700 according to the at least one second terminal

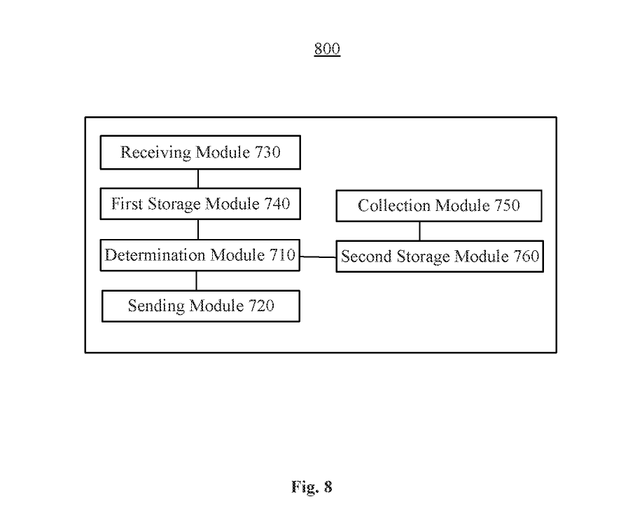

FIG. 8 is a block diagram of a wearable device 800, according to an exemplary embodiment. Referring to FIG. 8, in addition to the determination module 710 and the sending module 720 (FIG. 7), the wearable device 800 may further include a receiving module 730 and a first storage module 740. Alternatively or jointly, the wearable device 800 may further include a collection module 750 and a second storage module 760.

The receiving module 730 is configured to receive from the first terminal the identity information of the user who uses the wearable device 800.

The first storage module 740 is configured to store the identity information.

The collection module 750 is configured to collect the identity information entered into the wearable device 800.

The second storage module 760 is configured to store the identity information.

The notification message may include the identity information and a signal for requesting assistance. The notification message may be further configured to instruct the at least one second terminal to report to the server the location information of the at least one second terminal and the identity information of the user who uses the wearable device 700.

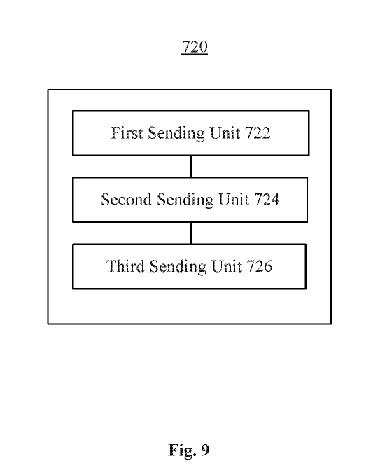

FIG. 9 is a block diagram of the sending module 720 (FIG. 7), according to an exemplary embodiment. Referring to FIG. 9, the sending module 720 includes a first sending unit 722, a second sending unit 724, and/or a third sending unit 726.

The first sending unit 722 is configured to broadcast the notification message via Bluetooth.

The second sending unit 724 is configured to broadcast the notification message via a wireless local area network.

The third sending unit 726 is configured to broadcast the notification message via a base station signal.

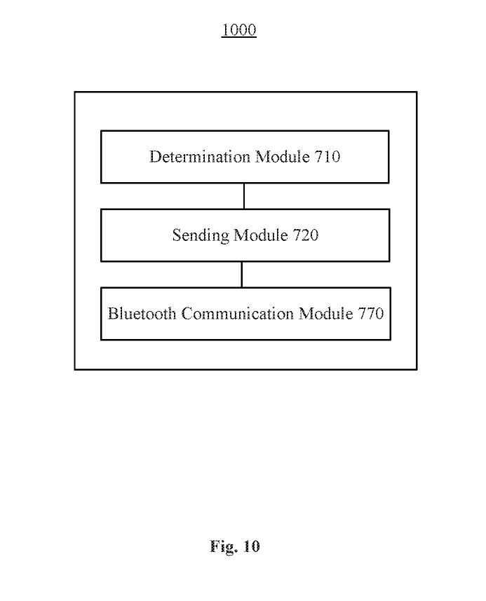

FIG. 10 is a block diagram of a wearable device 1000, according to an exemplary embodiment. Referring to FIG. 10, the short range communication connection may be a Bluetooth connection, and accordingly the wearable device 1000 may further include a Bluetooth communication module 770 configured to establish the Bluetooth connection with the first terminal.

With respect to the wearable devices described in the above embodiments, the specific manners of performing operations by the individual modules therein and the corresponding technical effects have been described in detail in the embodiments regarding the methods (FIGS. 1-6), which will not be elaborated herein.

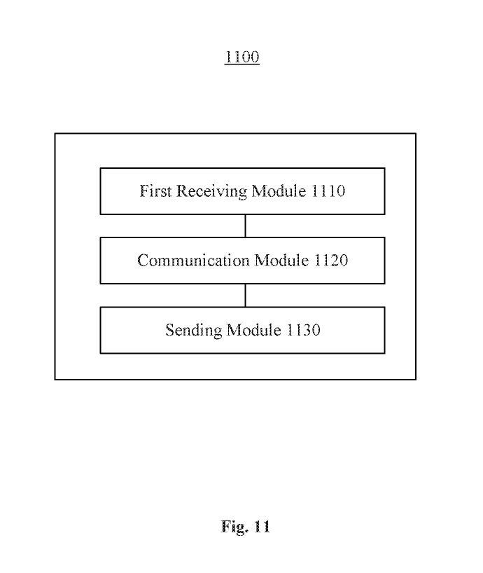

FIG. 11 is a block diagram of a terminal 1100, according to an exemplary embodiment. Referring to FIG. 11, the terminal 1100 includes a first receiving module 1110, a communication module 1120, and a sending module 1130.

The first receiving module 1110 is configured to receive a notification message broadcast by a wearable device. The notification message is configured to instruct the terminal 1100 to establish a short range communication connection with the wearable device and to report a connection notification to a server.

The communication module 1120 is configured to establish the short range communication connection with the wearable device.

The sending module 1130 is configured to send the connection notification to the server, so that the server locates the wearable device according to the terminal 1100. The connection notification is configured to indicate that the terminal 1100 has established the short range communication connection with the wearable device.

In some embodiments, the notification message may include identity information of the user who uses the wearable device and a signal for requesting assistance. Accordingly, the sending module 1130 is further configured to report the location information of the terminal 1100 and the identity information of the user to the server.

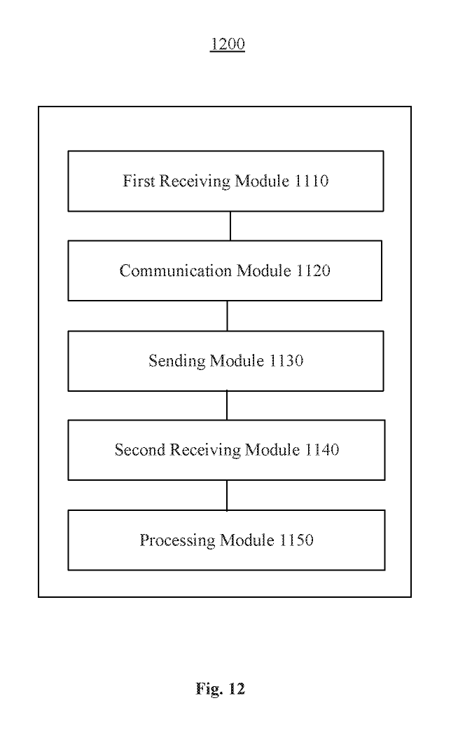

FIG. 12 is a block diagram of a terminal 1200, according to an exemplary embodiment. Referring to FIG. 12, the terminal 1200 further includes a second receiving module 1140 and a processing module 1150, in addition to the first receiving module 1110, the communication module 1120, and the sending module 1130 (FIG. 11).

The second receiving module 1140 is configured to receive a request from the server for activating a monitoring function of the terminal 1100.

The processing module 1150 is configured to activate, according to the request, a short range communication detection function, so that the communication module 1120 establishes the short range communication connection with the wearable device.

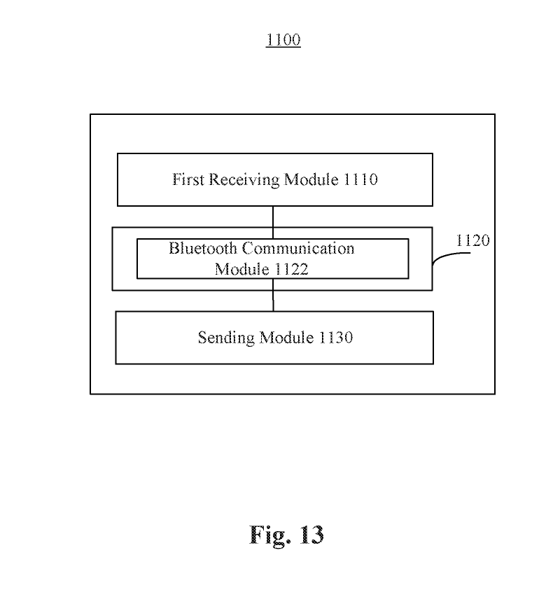

FIG. 13 is a block diagram of the terminal 1100, according to another exemplary embodiment. Referring to FIG. 13, the short range communication connection is a Bluetooth connection, and accordingly the communication module 1120 may include a Bluetooth communication unit 1122 configured to establish the Bluetooth connection with the wearable device.

With respect to the terminal 1100 described in the above embodiments, the specific manners of performing operations by the individual modules therein and the corresponding technical effects have been described in detail in the embodiments regarding the methods (FIGS. 1-6), which will not be elaborated herein.

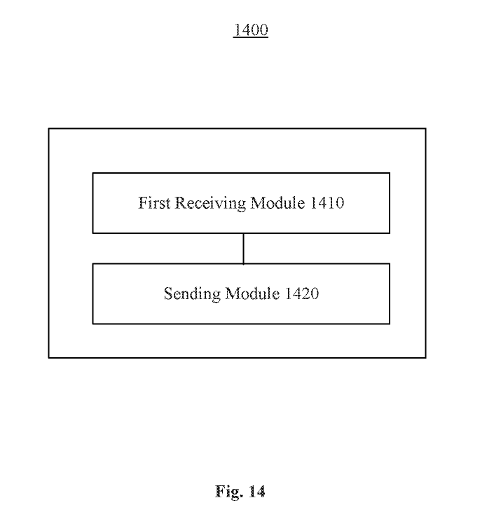

FIG. 14 is a block diagram of a server 1400, according to an exemplary embodiment. Referring to FIG. 14, the server 1400 includes a first receiving module 1410 and a sending module 1420.

The first receiving module 1410 is configured to receive, from a first terminal, location information of the first terminal and requesting-assistance information. The requesting-assistance information indicates that the first terminal is disconnected from a wearable device.

The sending module 1420 is configured to send, according to the location information of the first terminal, a request for activating a monitoring function to at least one second terminal within a preset distance from the first terminal. According to the request, the at least one second terminal activates a short range communication detection function to establish the short range communication connection with the wearable device.

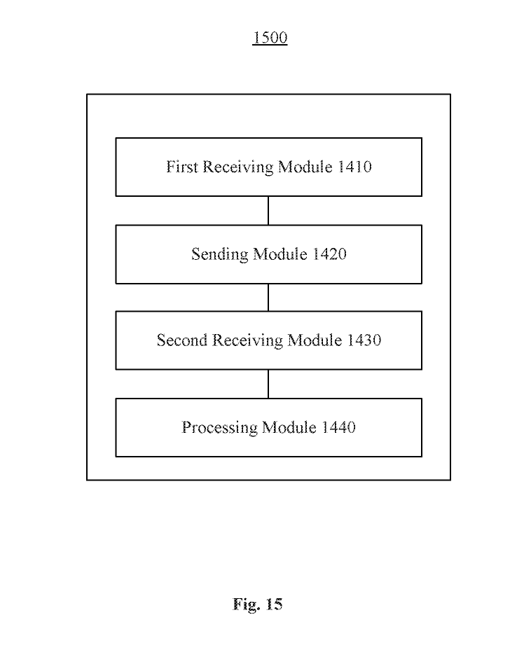

FIG. 15 is a block diagram of a server 1500, according to an exemplary embodiment. Referring to FIG. 15, the server 1500 further includes a second receiving module 1430 and a processing module 1440, in addition to the first receiving module 1410 and the sending module 1420 (FIG. 14).

The second receiving module 1430 is configured to receive, from the at least one second terminal, location information of the at least one second terminal and identity information of a user who uses the wearable device.

The processing module 1440 is configured to locate the wearable device according to the location information of the at least one second terminal.

With respect to the servers described in the above embodiments, the specific manners of performing operations by the individual modules therein and the corresponding technical effects have been described in detail in the embodiments regarding the methods (FIGS. 1-6), which will not be elaborated herein.

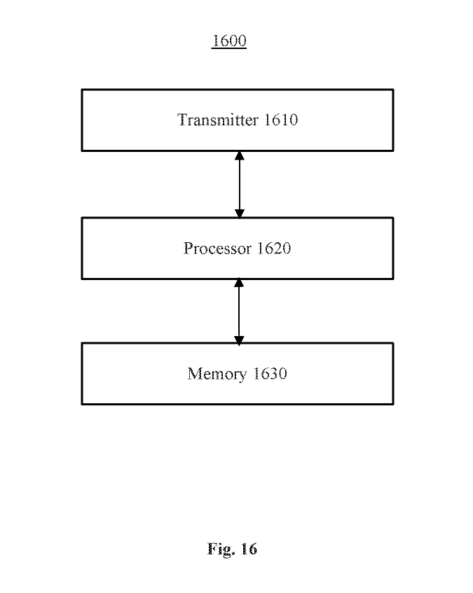

FIG. 16 is a block diagram of a wearable device 1600, according to an exemplary embodiment. Referring to FIG. 16, the wearable device 1600 includes a transmitter 1610, a processor 1620, and a memory 1630.

The memory 1630 stores instructions executable by the processor 1620, and the processor 1620 is configured to execute the instructions to determine whether a short range communication connection between the wearable device 1600 and a first terminal is disconnected.

The transmitter 1610 is configured to, if the processor 1620 determines that the short range communication connection with the first terminal is disconnected, broadcast a notification message for instructing at least one second terminal to establish a short range communication connection with the wearable device 1600 and to send a connection notification to a server, so that the server locates the wearable device 1600 according to the at least one second terminal

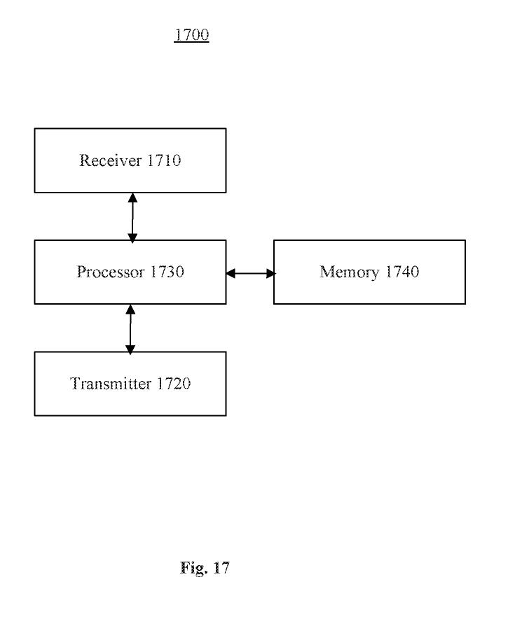

FIG. 17 is a block diagram of a terminal 1700, according to an exemplary embodiment. Referring to FIG. 17, the terminal 1700 includes a receiver 1710, a transmitter 1720, a processor 1730, and a memory 1740.

The receiver 1710 is configured to receive a notification message broadcast by a wearable device. The notification message is configured to instruct the terminal 1700 to establish a short range communication connection with the wearable device and to report a connection notification to a server.

The memory 1740 stores instructions executable by the processor 1730, and the processor 1730 is configured to execute the instructions to establish the short range communication connection with the wearable device.

The transmitter 1720 is configured to send the connection notification to the server, so that the server locates the wearable device according to the terminal 1700. The connection notification is configured to indicate that the terminal 1700 has established the short range communication connection with the wearable device.

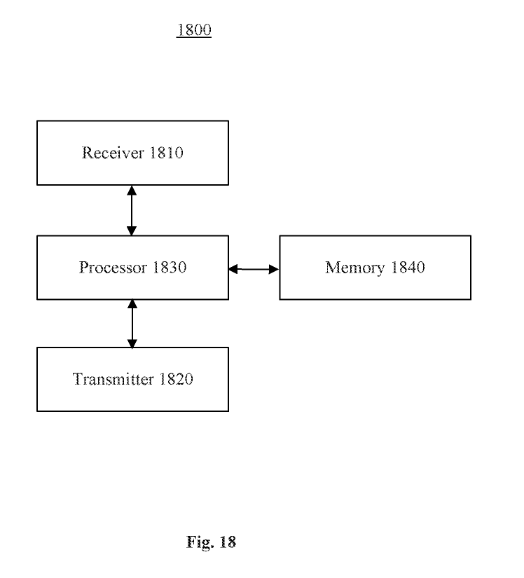

FIG. 18 is a block diagram of a server 1800, according to an exemplary embodiment. Referring to FIG. 18, the server 1800 includes a receiver 1810, a transmitter 1820, a processor 1830, and a memory 1840.

The receiver 1810 is configured to receive, from a first terminal, location information of the first terminal and requesting-assistance information. The requesting-assistance information indicates that the first terminal is disconnected from a wearable device.

The transmitter 1820 is configured to send, according to the location information of the first terminal, a request for activating a monitoring function to at least one second terminal within a preset distance from the first terminal, According to the request, the at least one second terminal activates a short range communication detection function to establish a short range communication connection with the wearable device.

The receiver 1810 is further configured to receive, from the at least one second terminal, location information of the at least one second terminal and identity information of a user who uses the wearable device.

The memory 1840 stores instructions executable by the processor 1830, and the processor 1830 is configured to locate the wearable device according to the location information reported by the at least one second terminal

In the above embodiments regarding the wearable device 1600, the terminal 1700, and the server 1800, it shall be understood that the processor may be a Central Processing Unit (CPU), a general-purpose processor, a Digital Signal Processor (DSP), an Application Specific Integrated Circuit (ASIC), and the like. The general-purpose processor may be a microprocessor or any common processor. The above memory may be a Read Only Memory (ROM), a Random Access Memory (RAM), a flash, a hard disk, or a solid state hard disk. The above-described methods may be performed by the hardware alone, or may be performed by the combination of both the hardware and software.

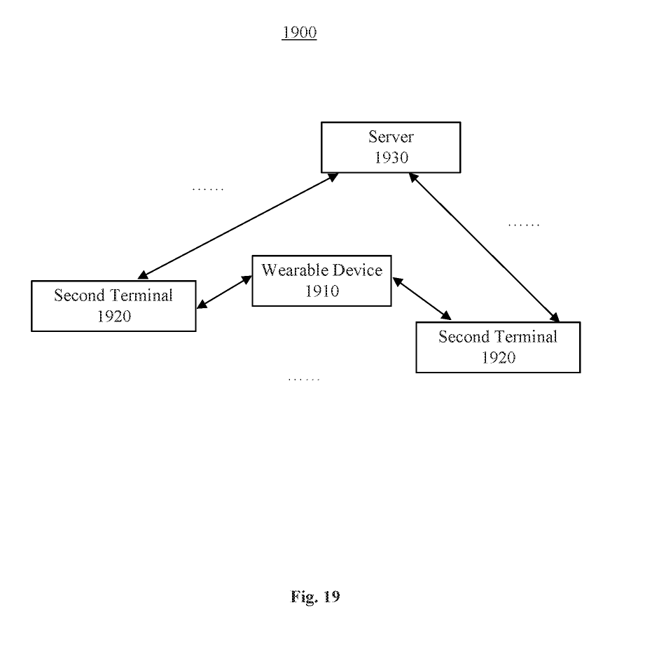

FIG. 19 is a schematic diagram illustrating a system 1900 for locating a wearable device, according to an exemplary embodiment. Referring to FIG. 19, the system 1900 includes a wearable device 1910, at least one second terminal 1920, and a server 1930. The operations of and the interactions among the wearable device 1910, the at least one second terminal 1920, and the server 1930 have been described in the above-disclosed method and device embodiments, which will not be elaborated herein.

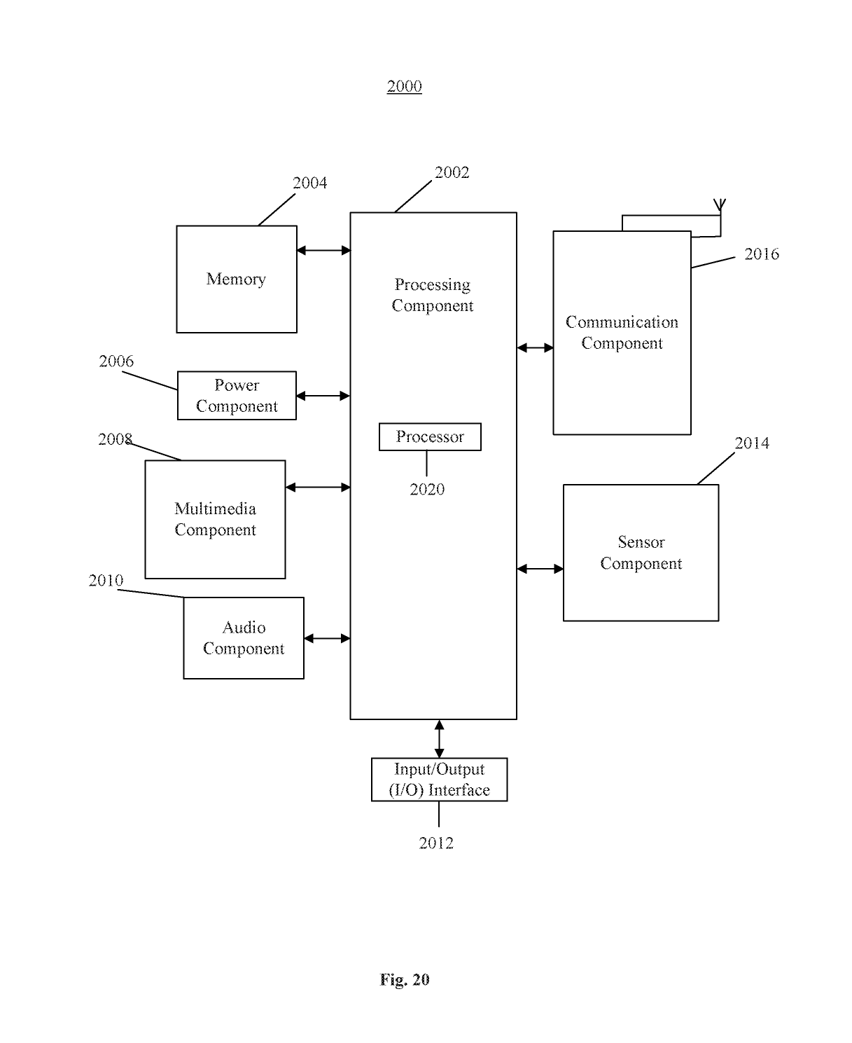

FIG. 20 is a block diagram of a wearable device 2000, according to an exemplary embodiment. The wearable device 2000 may be a smart watch, a smart wristband, wearable exercise equipment, a wearable medical device, and the like. Referring to FIG. 20, the wearable device 2000 may include one or more of the following components: a processing component 2002, a memory 2004, a power component 2006, a sensor component 2014, and a communication component 2016.

In some embodiments, the wearable device 2000 may also include a multimedia component 2008, an audio component 2010, and an input/output (I/0) interface 2012.

The processing component 2002 typically controls overall operations of the wearable device 2000, such as the operations associated with display, data communications, multimedia operations, and recording operations. The processing component 2002 may include one or more processors 2020 to execute instructions to perform all or part of the steps in the above described methods. Moreover, the processing component 2002 may include one or more modules which facilitate the interaction between the processing component 2002 and other components. For instance, the processing component 2002 may include a multimedia module to facilitate the interaction between the multimedia component 2008 and the processing component 2002.

The memory 2004 is configured to store various types of data to support the operation of the wearable device 2000. Examples of such data include instructions for any applications or methods operated on the wearable device 2000, various data, messages, pictures, video, etc. The memory 2004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a ROM, a magnetic memory, a flash memory, a magnetic or optical disk.

The power component 2006 provides power to various components of the wearable device 2000. The power component 2006 may include a power management system, one or more power sources, and any other components associated with the generation, management, and distribution of power in the wearable device 2000.

The multimedia component 2008 includes a screen providing an output interface between the wearable device 2000 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action.

The audio component 2010 is configured to output and/or input audio signals. For example, the audio component 2010 includes a microphone configured to receive an external audio signal when the electronic device 2000 is in an operation mode, such as a call mode, a recording mode, and a voice recognition mode. The received audio signal may be further stored in the memory 2004 or transmitted via the communication component 2016. In an embodiment, the audio component 2010 further includes a speaker to output audio signals.

The I/O interface 2012 provides an interface between the processing component 2002 and peripheral interface modules, such as a keyboard, a click wheel, buttons, and the like.

The sensor component 2014 includes one or more sensors to provide status assessments of various aspects of the wearable device 2000. For instance, the sensor component 2014 may detect an open/closed status of the wearable device 2000, relative positioning of components, e.g., the display and the keypad, of the wearable device 2000, a change in position of the wearable device 2000 or a component of the wearable device 2000, a presence or absence of user contact with the wearable device 2000, an orientation or an acceleration/deceleration of the wearable device 2000, and a change in temperature of the wearable device 2000. The sensor component 2014 may include a proximity sensor configured to detect the presence of nearby objects without any physical contact. The sensor component 2014 may also include a light sensor, such as a CMOS or CCD image sensor, for use in imaging applications. In some embodiments, the sensor component 2014 may also include an accelerometer sensor, a gyroscope sensor, a magnetic sensor, a pressure sensor, or a temperature sensor.

The communication component 2016 is configured to facilitate communication, wired or wirelessly, between the wearable device 2000 and other devices. The wearable device 2000 can access a wireless network based on a communication standard, such as WiFi, 2G, 3G, 4G, or a combination thereof. In one exemplary embodiment, the communication component 2016 receives a broadcast signal or broadcast associated information from an external broadcast management system via a broadcast channel In one exemplary embodiment, the communication component 2016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth technology, and other technologies.

In exemplary embodiments, the wearable device 2000 may be implemented with one or more ASICs, DSPs, digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 2004, executable by the processor 2020 in the wearable device 2000, for performing the above-described methods. For example, the non-transitory computer-readable storage medium may be a ROM, a RAM, a CD-ROM, a magnetic tape, a floppy disc, an optical data storage device, and the like.

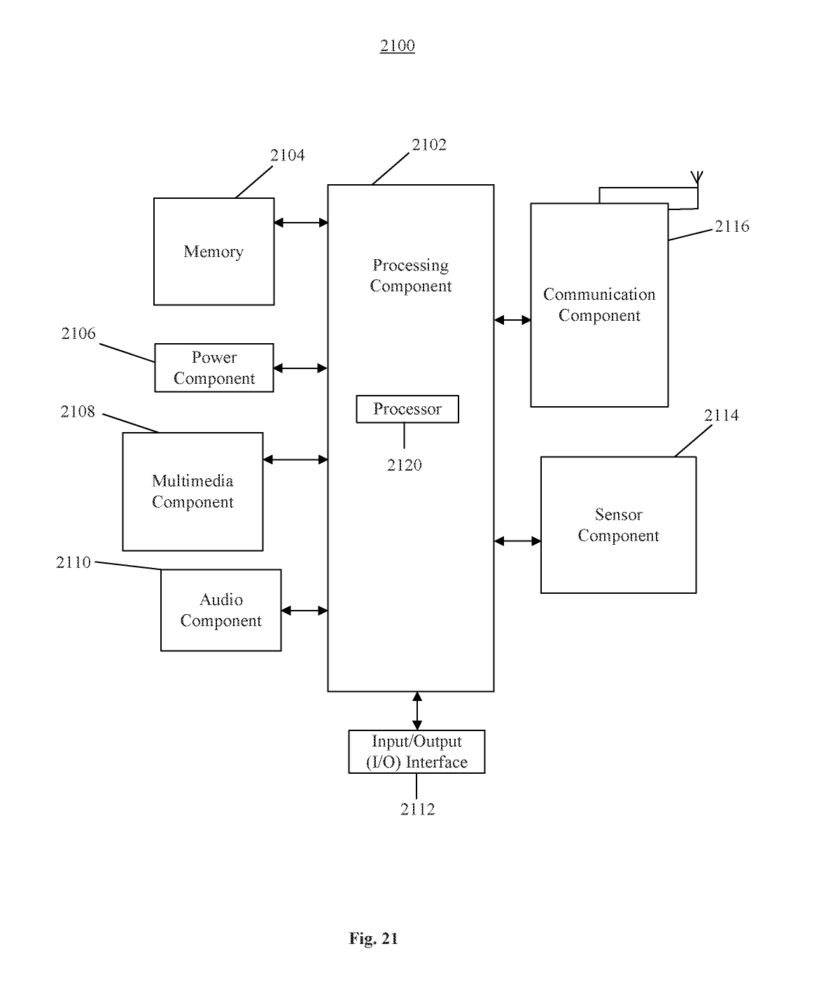

FIG. 21 is a block diagram of a terminal 2100, according to an exemplary embodiment. The terminal 2100 may be a device capable of accessing a network. For example, the terminal 2100 may be a mobile phone, a computer, a digital broadcast terminal, a messaging device, a gaming console, a tablet, a medical device, exercise equipment, a smart home device, a smart home appliance, and the like.

Referring to FIG. 21, the terminal 2100 may include one or more of the following components: a processing component 2102, a memory 2104, a power component 2106, a multimedia component 2108, an audio component 2110, an I/O interface 2112, a sensor component 2114, and a communication component 2116.

The processing component 2102 typically controls overall operations of the terminal 2100, such as the operations associated with display, telephone calls, data communications, multimedia operations, and recording operations. The processing component 2102 may include one or more processors 2120 to execute instructions to perform all or part of the steps in the above described methods. Moreover, the processing component 2102 may include one or more modules which facilitate the interaction between the processing component 2102 and other components. For instance, the processing component 2102 may include a multimedia module to facilitate the interaction between the multimedia component 2108 and the processing component 2102.

The memory 2104 is configured to store various types of data to support the operation of the terminal 2100. Examples of such data include instructions for any applications or methods operated on the terminal 2100, various data, messages, pictures, video, etc. The memory 2104 may be implemented using any type of volatile or non-volatile memory devices, or a combination thereof, such as a SRAM, an EEPROM, an EPROM, a PROM, a ROM, a magnetic memory, a flash memory, a magnetic or optical disk.

The power component 2106 provides power to various components of the terminal 2100. The power component 2106 may include a power management system, one or more power sources, and any other components associated with the generation, management, and distribution of power in the terminal 2100.

The multimedia component 2108 includes a screen providing an output interface between the terminal 2100 and the user. In some embodiments, the screen may include a LCD and a TP. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action.

The audio component 2110 is configured to output and/or input audio signals. For example, the audio component 2110 includes a microphone configured to receive an external audio signal when the terminal 2100 is in an operation mode, such as a call mode, a recording mode, and a voice recognition mode. The received audio signal may be further stored in the memory 2104 or transmitted via the communication component 2116. In some embodiments, the audio component 2110 further includes a speaker to output audio signals.

The I/O interface 2112 provides an interface between the processing component 2102 and peripheral interface modules, such as a keyboard, a click wheel, buttons.

The sensor component 2114 includes one or more sensors to provide status assessments of various aspects of the terminal 2100. For instance, the sensor component 2114 may detect an open/closed status of the terminal 2100, relative positioning of components, e.g., the display and the keypad, of the terminal 2100, a change in position of the terminal 2100 or a component of the terminal 2100, a presence or absence of user contact with the terminal 2100, an orientation or an acceleration/deceleration of the terminal 2100, and a change in temperature of the terminal 2100. The sensor component 2114 may include a proximity sensor configured to detect the presence of nearby objects without any physical contact. The sensor component 2114 may also include a light sensor, such as a CMOS or CCD image sensor, for use in imaging applications. In some embodiments, the sensor component 2114 may also include an accelerometer sensor, a gyroscope sensor, a magnetic sensor, a pressure sensor, or a temperature sensor.

The communication component 2116 is configured to facilitate communication, wired or wirelessly, between the terminal 2100 and other devices. The terminal 2100 can access a wireless network based on a communication standard, such as WiFi, 2G, 3G, 4G, or a combination thereof. In one exemplary embodiment, the communication component 2116 receives a broadcast signal or broadcast associated information from an external broadcast management system via a broadcast channel In one exemplary embodiment, the communication component 2116 further includes a NFC module to facilitate short-range communications. For example, the NFC module may be implemented based on a RFID technology, an IrDA technology, a UWB technology, a Bluetooth technology, and other technologies.

In exemplary embodiments, the terminal 2100 may be implemented with one or more ASICs, DSPs, DSPDs, PLDs, FPGAs, controllers, micro-controllers, microprocessors, or other electronic components, for performing the above described methods.

In exemplary embodiments, there is also provided a non-transitory computer-readable storage medium including instructions, such as included in the memory 2104, executable by the processor 2120 in the terminal 2100, for performing the above-described methods. For example, the non-transitory computer-readable storage medium may be a ROM, a RAM, a CD-ROM, a magnetic tape, a floppy disc, an optical data storage device, and the like.

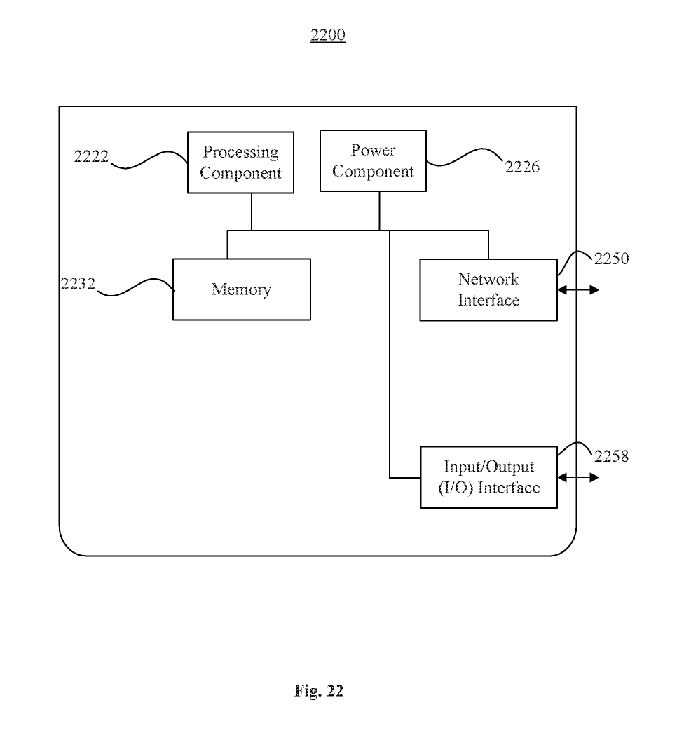

FIG. 22 is a block diagram of a server 2200, according to an exemplary embodiment. Referring to FIG. 22, the server 2200 includes a processing component 2222 that further includes one or more processors, and memory resources represented by a memory 2232 for storing instructions executable by the processing component 2222, such as application programs. The application programs stored in the memory 2232 may include one or more modules each corresponding to a set of instructions. Further, the processing component 2222 is configured to execute the instructions to perform the solutions for locating a wearable device at the server side.

The server 2200 may also include a power component 2226 configured to perform power management of the server 2200, wired or wireless network interface(s) 2250 configured to connect the server 2200 to a network, and an I/O interface 2258. The server 2200 may operate based on an operating system stored in the memory 2232, such as Windows Server™, Mac OS X™, Unix™, Linux™, FreeBSD™, or the like.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present invention is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A method for locating a wearable device, comprising:
determining, by the wearable device, whether a first short range communication connection between the wearable device and a first terminal is disconnected; and
when it is determined that the first short range communication connection is disconnected, broadcasting, by the wearable device, a notification message configured to instruct a second terminal to:
establish a second short range communication connection with the wearable device, and
send a connection notification to a server, wherein the server locates the wearable device according to the second terminal.

2. The method according to claim 1, wherein:
the notification message comprises identity information of a user who uses the wearable device and a signal for requesting assistance,
wherein the notification message is further configured to instruct the second terminal to report to the server:
location information of the second terminal, and
the identity information of the user.

3. The method according to claim 2, further including at least one of:
receiving, by the wearable device, the identity information from the first terminal and storing the identity information in the wearable device; or
collecting, by the wearable device, the identity information input into the wearable device, and storing the identity information in the wearable device.

4. The method according to claim 1, wherein the broadcasting, by the wearable device, of the notification message includes at least one of:
broadcasting the notification message via Bluetooth;
broadcasting the notification message via a wireless local area network; or
broadcasting the notification message via a base station signal.

5. The method according to claim 1, wherein the short range communication connection is a Bluetooth connection, the method further comprising:
before the determination of whether the first short range communication connection between the wearable device and the first terminal is disconnected, establishing, by the wearable device, the Bluetooth connection with the first terminal.

6. The method according to claim 1, further comprising:
receiving, by the second terminal, the notification message broadcast by the wearable device;
establishing, by the second terminal, the second short range communication connection with the wearable device; and
sending the connection notification to the server, wherein the connection notification is configured to indicate that the second terminal has established the second short range communication connection with the wearable device.

7. The method according to claim 6, wherein the notification message comprises identity information of a user who uses the wearable device and a signal for requesting assistance, the method further comprising:
reporting, by the second terminal, location information of the second terminal and the identity information of the user to the server.

8. The method according to claim 6, further comprising:
receiving, by the second terminal, from the server a request for activating a monitoring function of the second terminal; and
activating, by the second terminal, a short range communication detection function according to the request, to establish the second short range communication connection with the wearable device.

9. The method according to claim 6, wherein the second short range communication connection is a Bluetooth connection, wherein the establishing, by the second terminal, of the second short range communication connection with the wearable device comprises:
establishing the Bluetooth connection with the wearable device.

10. The method according to claim 1, further comprising:
receiving, by the server, from the first terminal location information of the first terminal and requesting-assistance information indicating that the first terminal is disconnected from the wearable device; and
sending, by the server, to the second terminal a request for activating a monitoring function of the second terminal, wherein the second terminal is within a predetermined distance from the first terminal, and activates a short range communication detection function to establish the second short range communication connection with the wearable device.

11. The method according to claim 10, further comprising:
receiving, by the server, from the second terminal location information of the second terminal and identity information of a user who uses the wearable device; and
locating, by the server, the wearable device according to the location information of the second terminal.

12. A wearable device, comprising:
a transmitter;
a processor; and
a memory for storing instructions executable by the processor;
wherein:
the processor is configured to determine whether a first short range communication connection between the wearable device and a first terminal is disconnected; and
the transmitter is configured to, when the processor determines that the first short range communication connection with the first terminal is disconnected, broadcast a notification message configured to instruct a second terminal to:
establish a second short range communication connection with the wearable device, and
send a connection notification to a server, wherein the server locates the wearable device according to the second terminal.

13. The wearable device according to claim 12, wherein
the notification message comprises identity information of a user who uses the wearable device and a signal for requesting assistance,
wherein the notification message is further configured to instruct the second terminal to report to the server:
location information of the second terminal, and
the identity information of the user.

14. The wearable device according to claim 13, wherein the processor is further configured to:
receive the identity information from the first terminal, and save the identity information in the memory; or
collect the identity information input into the wearable device, and save the identity information in the memory.

15. The wearable device according to claim 12, wherein the transmitter is configured to:
broadcast the notification message via Bluetooth;
broadcast the notification message via a wireless local area network; or
broadcast the notification message via a base station signal.

16. A terminal, comprising:
a receiver;
a transmitter;
a processor; and
a memory for storing instructions executable by the processor;
wherein:
the receiver is configured to receive a notification message broadcast by a wearable device, wherein the notification message is configured to instruct the terminal to establish a short range communication connection with the wearable device, and to report a connection notification to a server, wherein the server locates the wearable device according to the terminal;
the processor is configured to establish the short range communication connection with the wearable device; and
the transmitter is configured to send the connection notification to the server, the connection notification being configured to indicate that the terminal has established the short range communication connection with the wearable device.

17. The terminal according to claim 16, wherein
the notification message comprises identity information of a user who uses the wearable device and a signal for requesting assistance,
wherein the processor is further configured to report to the server:
location information of the terminal, and
the identity information of the user.

18. The terminal according to claim 16, wherein the processor is further configured to:
receive a request, from the server, for activating a monitoring function of the terminal; and
activate a short range communication detection function according to the request, to establish the short range communication connection with the wearable device.

19. The terminal according to claim 16, wherein the short range communication connection is a Bluetooth connection, wherein the processor is further configured to:
establish the Bluetooth connection with the wearable device.

20. A server, comprising:
a receiver;
a transmitter;
a processor; and
a memory for storing instructions executable by the processor;
wherein:
the receiver is configured to:
receive, from a first terminal, location information of the first terminal and requesting-assistance information indicating that the first terminal is disconnected from a wearable device, and
receive, from a second terminal, location information of the second terminal and identity information of a user who uses the wearable device, the second terminal being within a predetermined distance from the first terminal;
the transmitter is configured to send the second terminal a request for activating a monitoring function of the second terminal, wherein the second terminal activates a short range communication detection function to establish a short range communication connection with the wearable device; and
the processor is configured to locate the wearable device according to the location information of the second terminal.
